(19) United States
(12) Patent Application Publication
(10) Pub. No.: US 2020/0122283 A1
(43) Pub. Date: Apr. 23, 2020

(54) SWARF-GUIDING DEVICE

(71) Applicant: OKUMA Corporation, Niwa-gun (JP)

(72) Inventor: Hiroyuki SUGIURA, Niwa-gun (JP)

(21) Appl. No.: 16/658,425

(22) Filed: Oct. 21, 2019

(30) Foreign Application Priority Data
Oct. 19, 2018 (JP) 2018-197670

(51) Int. Cl. B23Q 11/10

(52) U.S. Cl. CPC B23Q 11/1076; B25J 11/0055

(57) ABSTRACT

A swarf-guiding device guides stringy swarf continuously generated from a cut point. The swarf-guiding device includes a jet nozzle that jets coolant, a nozzle-holding device that holds the jet nozzle such that a position and an orientation of the jet nozzle are changeable, and a controller that controls the nozzle-holding device such that the coolant hits the stringy swarf at a downstream position from a cut point in a tool-feeding direction.

### CROSS REFERENCE TO RELATED APPLICATION

This application claims priority to Japanese Patent Application No. 2018-197670 filed on Oct. 19, 2018, which is incorporated herein by reference in its entirety including the specification, claims, drawings, and abstract.

### TECHNICAL FIELD

The present specification discloses a swarf-guiding device that guides stringy swarf that is continuously generated from a cut point during lathe-turning.

### BACKGROUND

In cutting machining, swarf is generated during machining. Coolant is often jetted to a cut point in order to remove such swarf, improve life spans of tools, and enhance quality of a machined surface. However, the cut point may be gradually displaced as machining progresses. Techniques to move a jet nozzle of coolant such that coolant can be jetted while following the displaced cut point have been proposed. For example, JP 2016-124046A discloses techniques to move a jet nozzle of coolant attached to a distal end of an articulated robot such that coolant is jetted to a cut point determined as required.

In lathe-turning in which a tool is pressed against a rotatably-held workpiece to process the workpiece, long, continuous, stringy swarf tends to be generated. In techniques in which coolant is jetted to a cut point as in JP 2016-124046A, while short, discontinuous swarf can be easily blown away, it has been difficult to blow away stringy swarf generated in lathe-turning. Thus, in related techniques, stringy swarf may get caught on a rotating workpiece or a chuck and be rotated together and to be entangled around the workpiece or the chuck. Stringy swarf entangled around the workpiece or the chuck may cause problems such as reducing accuracy in machining, scarring a machining surface, deteriorating a tool, or stopping machining operations.

Techniques to prevent entanglement of stringy swarf have been proposed. For example, it has been proposed to cut the stringy swarf into small pieces in order to prevent entanglement of stringy swarf. As the techniques to cut swarf, chip breakers or high pressure coolant may be used, or interrupted cutting may be performed. However, chip breakers can be used only in limited circumstances. High pressure coolant requires a large pump or other devices, increasing an introduction cost. In addition, when using high pressure coolant, because oil mist tends to occur, environment in the factory may be deteriorated. While the interrupted cutting can be easily introduced, problems including reduction in life spans of tools or increase in lead time may occur. In short, swarf cutting techniques have had various problems.

The present specification discloses a swarf-guiding device that prevents entanglement of stringy swarf by guiding the stringy swarf to an appropriate direction.

### SUMMARY

A swarf-guiding device according to the present disclosure guides stringy swarf that is continuously generated from a cut point during lathe-turning. The swarf-guiding device includes a jet nozzle that jets coolant; a nozzle-holding device that holds the jet nozzle such that a position and an orientation of the jet nozzle are changeable; and a controller that controls the nozzle-holding device such that the coolant hits the stringy swarf at a downstream position from a cut point in a tool-feeding direction.

Because the moment around the cut point can be increased by hitting the stringy swarf with the coolant at a position separated from the cut point, the flow direction of the stringy swarf can be efficiently guided. Because the stringy swarf generally flows downstream from the cut point in the tool-feeding direction, the coolant can reliably hit the stringy swarf by directing the coolant at a downstream position in the tool-feeding direction. In this way, the stringy swarf is guided to an appropriate direction, and entanglement of the stringy swarf can be efficiently prevented.

The controller may control the nozzle-holding device such that the jet nozzle moves back and forth in the tool-feeding direction at a downstream position from the cut point in the tool-feeding direction.

The coolant can more reliably hit the stringy swarf even with variety in flow directions of the stringy swarf, by moving the jet nozzle back and forth in the tool-feeding direction.

With the swarf-guiding device mounted to a horizontal lathe in which a workpiece is held to be rotatable about a horizontal axis, the controller may control the nozzle-holding device such that a jet direction of the coolant is tilted downward from a horizontal axis.

In the above configuration, the stringy swarf is guided downward in the gravity direction. When the stringy swarf of more than a certain amount flows downward, the own weight of such stringy swarf causes the subsequent stringy swarf to automatically flow downward. In this way, entanglement of the stringy swarf around the workpiece can be reliably prevented.

With the swarf-guiding device mounted to a horizontal lathe in which a workpiece is held to be rotatable about a horizontal axis, the controller may control the nozzle-holding device such that the jet nozzle is located higher than the cut point and the coolant is jetted in a substantially tangential direction of the workpiece.

When no measures are taken for the stringy swarf that reaches higher than the cut point, the stringy swarf may be entangled around the workpiece. The coolant can hit the stringy swarf that reaches higher than the cut point, by jetting the coolant from a higher position than the cut point, preventing entanglement of the stringy swarf. By jetting the coolant in a substantially tangential direction of the workpiece, because the coolant can more easily enter between the work and the stringy swarf that has been entangled around the workpiece, the stringy swarf can be peeled off from the workpiece more easily. In this way, the entanglement of the stringy swarf around the workpiece can be more reliably prevented.

The swarf-guiding device may be mounted to a vertical lathe in which a workpiece is rotatably held by a spindle that is directed vertically upwards. The controller may control the nozzle-holding device such that a jet direction of the coolant is tilted upward from a horizontal axis.

In the above configuration, the stringy swarf is unlikely to be in contact with a chuck that is disposed under the workpiece. As a result, the entanglement of the stringy swarf can be efficiently prevented.

The nozzle-holding device may be an articulated robot that has at least four degrees of freedom.

In the above configuration, the stringy swarf can be guided to a desired direction, because the position and the orientation of the jet nozzle can be freely changed.

The jet nozzle may mix the coolant and air at a distal end of the jet nozzle.

In the above configuration, because the dynamic pressure of the coolant can be enhanced, the stringy swarf can be more reliably guided.

The swarf-guiding device according to the present disclosure can prevent entanglement of stringy swarf by guiding the stringy swarf to an appropriate direction.

### BRIEF DESCRIPTION OF DRAWINGS

Embodiments of the present disclosure will be described based on the following figures, wherein:

FIG. 1 is a schematic side view of a machine tool that incorporates a swarf-guiding device;

FIG. 2 is a front view of the machine tool shown in FIG. 1;

FIG. 3 is a schematic view showing swarf during lathe-turning as viewed from a Z-axis direction;

FIG. 4 is a schematic view showing swarf during lathe-turning as viewed from a Y-axis direction;

FIG. 5 is a schematic view showing swarf during lathe-turning after some progress from the lathe-turning shown in FIG. 3;

FIG. 6 is a schematic view showing swarf during lathe-turning after some progress from the lathe-turning shown in FIG. 4;

FIG. 7 is a schematic view showing how swarf is guided as viewed from a Z-axis direction;

FIG. 8 is a schematic view showing how swarf is guided as viewed from a Y-axis direction;

FIG. 9 is a schematic view showing how swarf is guided in another embodiment; and

FIG. 10 is a schematic view showing how swarf is guided in a vertical lathe.

### DESCRIPTION OF EMBODIMENTS

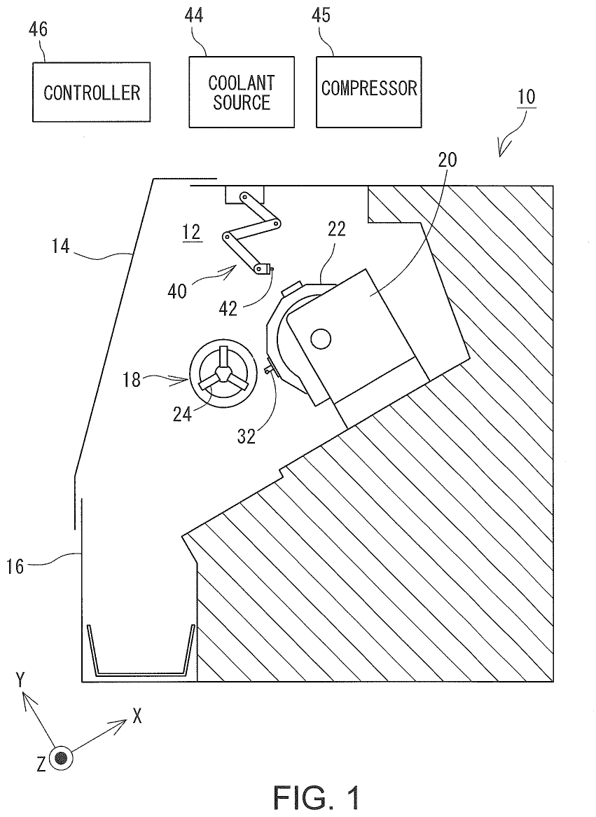

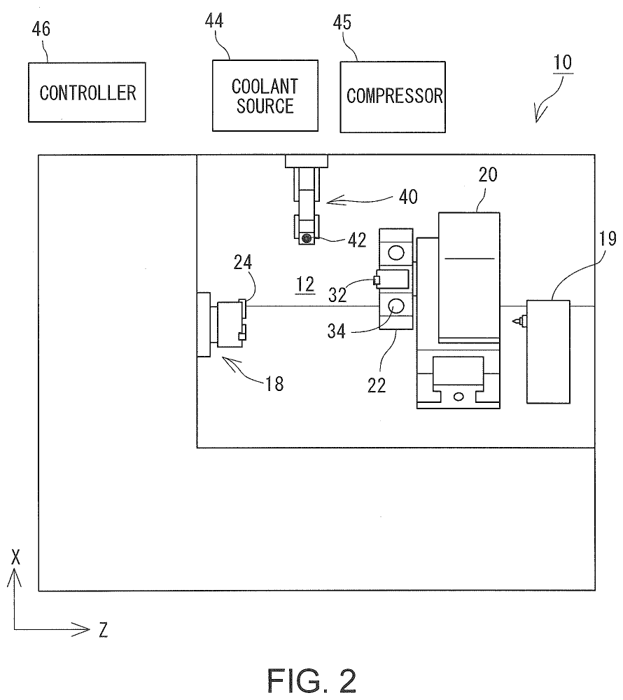

A swarf-guiding device and a machine tool 10 that incorporates the swarf-guiding device are described below with reference to the drawings. FIG. 1 is a schematic side view of the machine tool 10 that incorporates the swarf-guiding device; and FIG. 2 is a front view of the machine tool 10 shown in FIG. 1. In description below, the direction in parallel to the rotation axis of a spindle 18 is called a “Z axis”, the direction in parallel to a moving direction of a tool post 20, which is perpendicular to the Z axis, is called an “X axis”, and the direction perpendicular to the X and Z axes is called a “Y axis”. In the Z axis, the direction towards the tool post 20 from the spindle 18 is described as a positive direction; in the X axis, the direction towards the tool post 20 from the spindle 18 is described as a positive direction; and in the Y axis, the upward direction from the spindle 18 is described as a positive direction.

The machine tool 10 is a lathe including the spindle 18 that rotatably holds a workpiece. Specifically, the machine tool 10 according to the present embodiment is a turning center including a turret 22 that holds multiple tools 32 of different types. The machine tool 10 described here is merely an example. The techniques according to the present disclosure may be applied to any machine tools in any embodiments so long as lathe-turning can be performed. For example, the swarf-guiding device according to the present disclosure may be applied to a multi-tasking machine in which a lathe and a milling machine are combined. In description below, the machine tool 10 is described as a turning center.

The machine tool 10 is housed in an enclosure 16 of a machining chamber 12 of the machine tool 10. A large opening is provided at the front of the machining chamber 12, and the opening is opened or closed by a door 14. An operator can access components inside the machining chamber 12 through the opening. During machining, the door 14 provided for the opening is closed to ensure safety and maintain environment.

The machine tool 10 includes the spindle 18 that rotatably holds one end of a workpiece 30, the tool post 20 that holds a tool 32, and a tailstock 19 that holds the other end of the workpiece 30. The spindle 18 is rotatable using a motor (not shown). A chuck 24 or a collet that can removably hold the workpiece 30 is provided on an end surface of the spindle 18. The spindle 18 and the chuck 24 rotate about a rotational axis extending in a horizontal direction (a direction along the Z axis).

The tailstock 19 is disposed to oppose the spindle 18 along the Z axis such that the spindle 18 holds one end of the workpiece 30 and the tailstock 19 holds the other end. The tailstock 19 is movable towards or away from the workpiece 30 along the Z axis.

The tool post 20 is a tool-holding device that holds the tool 32. The tool post 20 is movable along the Z axis, which is in parallel with a longitudinal axis of the workpiece 30. The tool post 20 can also move towards or away from the workpiece 30 in a radial direction of the workpiece 30. As is obvious from FIG. 1, the X axis is tilted with respect to the horizontal direction such that when viewed from the opening of the machining chamber 12, the X axis is tilted upwards towards the back.

The turret 22 that can hold multiple tools 32 is disposed on one of the Z-axial end surfaces of the tool post 20. The turret 22 is a polygon when viewed in a Z-axis direction and rotatable about an axis in parallel to the Z axis. The turret 22 includes, on the circumferential surface, multiple toolholders to which the tools 32 can be attached. The tool 32 to be used for machining can be changed by rotating the turret 22.

A robot 40 that serves as a portion of the swarf-guiding device is disposed inside the machining chamber 12. The robot 40 serves as a nozzle-holding device that holds a jet nozzle 42 described further below such that the position and the orientation of the jet nozzle 42 can be changed. In the present embodiment, the robot 40 is a multiple-degrees-of-freedom robot disposed inside the machining chamber 12; in other words, an articulated robot including multiple links connected to one another via at least one joint. Although no limitation is imposed on the configuration of the robot 40, in order to freely change the position and the orientation of the jet nozzle 42 described further below, the robot 40 may have at least four degrees of freedom.

Although the robot 40 in the present embodiment is disposed on a ceiling of the machining chamber 12, the robot 40 may be disposed at a different location so long as the coolant jetted from the jet nozzle 42 can hit stringy swarf 50. Thus, the robot 40 may be disposed on a side wall of the machining chamber 12, the spindle 18, the tool post 20, or any other location.

The jet nozzle 42 as an end effector is attached to the robot 40. The jet nozzle 42 jets coolant, serving as a part of the swarf-guiding device. In the present embodiment, the stringy swarf 50 described further below is guided to a desired direction by the pressure of the coolant jetted from the jet nozzle 42. The jet nozzle 42 is connected in fluid communication with a coolant source 44 via a coolant pipe to supply the coolant to the jet nozzle 42. The coolant pipe may extend inside or outside the robot 40.

In the present embodiment, the coolant is mixed with compressed air in the vicinity of the distal end of the jet nozzle 42 before being jetted. The jet nozzle 42 is connected in fluid communication with a compressor 45 via an air pipe. The air pipe may extend inside or outside the robot 40. In either case, the dynamic pressure of the coolant can be increased by mixing the coolant and the air, enhancing a performance to guide the stringy swarf 50.

The jet nozzle 42 and the robot 40 are not required to be connected at all times, and may be disconnected as required. For example, the end effector attached to the robot 40 may be replaceable. Specifically, when the robot 40 is used to carry the workpiece 30, an end effector having a hand mechanism may be attached to the robot 40, whereas when the robot 40 is used as a swarf-guiding device, a jet nozzle end effector may be attached to the robot 40.

Although in the present embodiment a jet nozzle is used as the end effector of the robot 40, the jet nozzle may be disposed separately from the robot 40. For example, the jet nozzle may be disposed on an element other than the robot 40 via a flexible tube, for example, on a wall of the machining chamber 12 or the tool post 20. In such a case, the robot 40 changes the position of the jet nozzle 42 by moving the arm while holding the jet nozzle with the end effector (for example, a hand mechanism).

A controller 46 controls respective sections of the machine tool 10 in accordance with instructions from an operator. The controller 46 may include, for example, a CPU that performs various operations, and a memory that stores various control programs or control parameters. The controller 46 also has a communication function to transmit or receive various data, for example, numerical control (NC) program data, to or from other devices. The controller 46 may include, for example, an NC controller that calculates the position of the tool 32 or the workpiece as required. The controller 46 may be configured from a single unit or a combination of two or more computing units.

For example, when the workpiece 30 is machined by the tool 32, the controller 46 controls the movement of the spindle 18, the tool post 20, and the tailstock 19. As the controller 46 according to the present embodiment functions also as a controller for the swarf-guiding device, the controller 46 controls the robot 40, the jet nozzle 42, and various valves and pumps, as required.

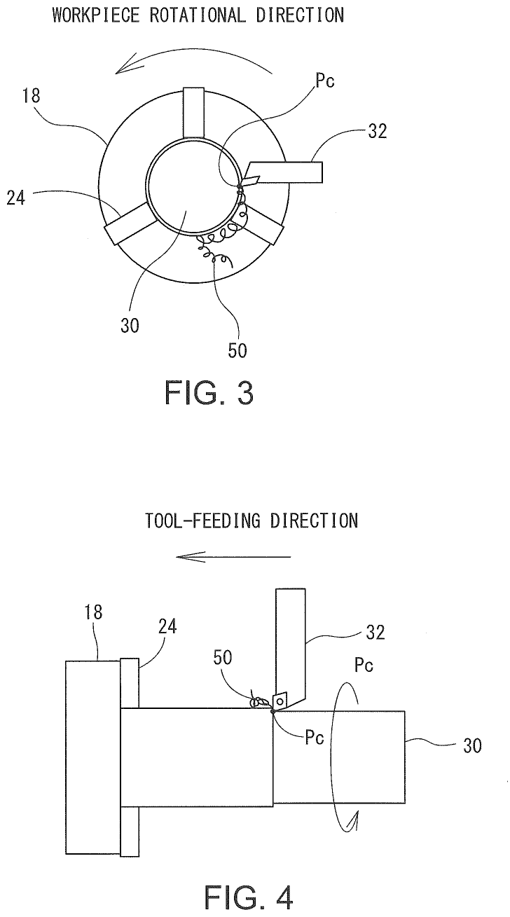

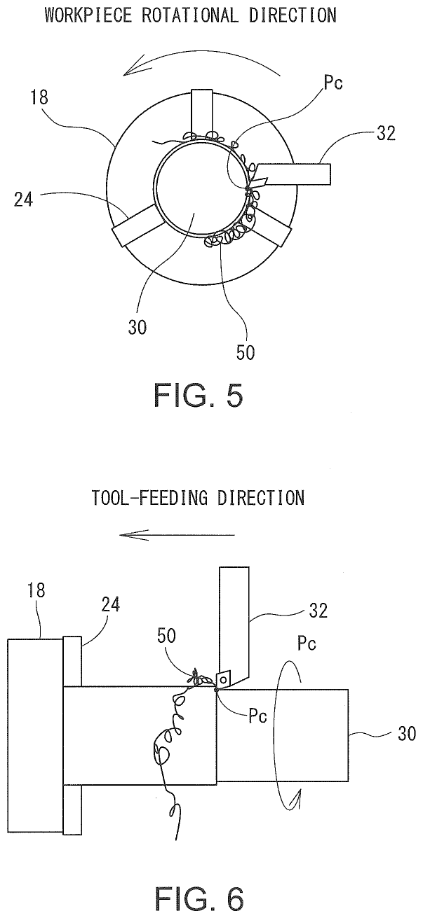

The swarf 50 that is guided by the swarf-guiding device is described below with reference to FIG. 3 to FIG. 6. FIG. 3 and FIG. 4 are schematic views showing swarf during lathe-turning. FIG. 3 is viewed from a Z-axis direction, whereas FIG. 4 is viewed from a Y-axis direction. FIG. 5 and FIG. 6 are schematic views showing swarf during lathe-turning after some progress. FIG. 5 is viewed from a Z-axis direction, whereas FIG. 6 is viewed from a Y-axis direction.

In lathe-turning, a cutting process is performed by pressing the tool 32 against the workpiece 30 in rotation. As shown in FIG. 3, the workpiece 30 is rotated in an upward direction in relation to a cut point Pc. The tool 32 is moved along the Z axis. In such lathe-turning, the swarf 50 is generated continuously from the cut point Pc. The swarf 50 is unlikely to be interrupted in lathe-turning but tends to form a continuous, string-like shape. In description below, continuous, string-like swarf is called “stringy swarf”.

As shown in FIG. 3 and FIG. 4, in earlier steps, such stringy swarf 50 flows lower than the cut point Pc and towards downstream of the workpiece feeding direction. However, when a part of the stringy swarf 50 comes into contact with an outer surface of the workpiece 30 during the lathe-turning, the stringy swarf 50 may be brought upwards onto the upper side of the workpiece 30 with the rotation of the workpiece 30, as shown in FIG. 5 and FIG. 6. If such a state is left without taking any measures, the workpiece 30 and the stringy swarf 50 may come into contact with each other intermittently, causing the stringy swarf 50 to rotate with and around the workpiece 30. When the stringy swarf 50 is rotated for a full rotation, the rotated stringy swarf 50 may be entangled with newly generated stringy swarf 50 from the cut point Pc and become inseparable. In such a case, because the stringy swarf 50 may continue to be entangled together with the rotation of the workpiece 30 and the stringy swarf 50 continues to be in contact with the surface of the workpiece 30, the machined surface is likely to be damaged.

In order to prevent such entanglement of stringy swarf, techniques to break the stringy swarf have been proposed. Specifically, it has been proposed to break the swarf as required with a chip breaker attached to the tip of a blade of the tool 32. However, there are many cases where the chip breakers cannot be used, depending on machining conditions. For example, for an alloy such as a chromium molybdenum steel material (an SCM alloy in JIS standard), it is difficult to break swarf with the chip breaker because of its high toughness.

It is also proposed to break the swarf by partially applying high pressure coolant. However, the high pressure coolant requires a large pump, pressure resistant pipe, or the like, resulting in increased cost and requiring a larger installation space. Further, because oil mist is likely to occur, the high pressure coolant may cause an issue of deteriorated factory environment. Techniques to break the swarf by performing the lathe-turning intermittently is also known. However, such intermittent cutting may also cause an issue of shortened life span of the tool 32 and increased lead time.

In the lathe-turning, coolant is generally applied to the cut point Pc. Coolant helps to peel swarf off to some degree. In particular, by using a method to jet coolant through a hole (called an oil hole) formed in the tool 32 or the toolholder, the coolant can be applied to the cut point Pc more accurately because the coolant jet position can always follow the cut point Pc.

However, although setting the target position of the coolant to the cut point Pc is effective to reduce a temperature rise of the tool 32 or improve accuracy of the machining surface, it does not significantly contribute to prevent entanglement of the stringy swarf 50. This is because the movement of the stringy swarf 50 away from the cut point Pc cannot be controlled in the method in which the coolant is applied to the cut point Pc.

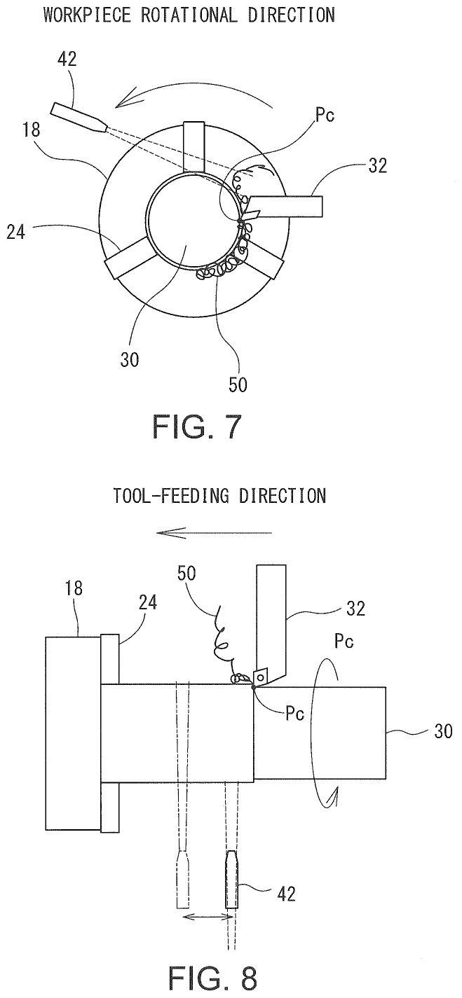

In the present disclosure, the coolant hits the stringy swarf 50 at a position away from the cut point Pc in order to prevent entanglement of the stringy swarf 50. This is described with reference to FIG. 7 and FIG. 8, which are schematic views showing how swarf is guided. FIG. 7 is viewed from a Z-axis direction, whereas FIG. 8 is viewed from a Y-axis direction.

In the present embodiment, in order to guide the stringy swarf 50, the controller 46 drives the robot 40 to control the position and the orientation of the jet nozzle 42. Specifically, the controller 46 obtains the position of the cut point Pc, and controls the position and the orientation of the jet nozzle 42 to jet the coolant to the stringy swarf 50 at a position that is away from and on the downstream side of the cut point Pc in the tool-feeding direction. By jetting the coolant to a position away from the cut point Pc, because the area of the stringy swarf 50 receiving the coolant is broadened, the force applied to the stringy swarf 50 is increased. Because the moment around the cut point Pc is increased by jetting the coolant to a position away from the cut point Pc, the stringy swarf 50 can be more reliably guided.

The stringy swarf 50 that is generated in the lathe-turning typically flows downstream in the tool-feeding direction. In other words, the downstream side of the cut point Pc in the tool-feeding direction is the direction to which the stringy swarf 50 flows. By jetting the coolant to a position that is away from and on the downstream side of the cut point Pc in the tool-feeding direction, the coolant can more reliably hit the stringy swarf 50.

As shown in FIG. 8, in the present embodiment, the controller 46 controls the robot 40 to move the jet nozzle 42 back and forth in the tool-feeding direction. By moving the jet nozzle 42 in the tool-feeding direction in this manner, the coolant can more reliably hit the stringy swarf 50 even with some dispersions in flow directions of the stringy swarf 50.

As shown in FIG. 7, in the present embodiment, the controller 46 controls the robot 40 such that a coolant jet direction is tilted downward from a horizontal axis. In such a configuration, the stringy swarf 50 tends to be guided downward in the gravity direction without being entangled around the workpiece 30. When the stringy swarf 50 of more than a certain amount flows downward, the own weight of such stringy swarf 50 causes the newly generated stringy swarf 50 to also flow downward. In this way, entanglement of the stringy swarf 50 can be reliably prevented.

As shown also in FIG. 7, in the present embodiment, the controller 46 controls the robot 40 to position the jet nozzle 42 at a higher position than the cut point Pc and the coolant is jetted in a substantially tangential direction of the workpiece 30. As described above, without taking any measures, the stringy swarf 50 may get caught on the workpiece 30 and be wound upwards as shown in FIG. 5 and FIG. 6. In order to prevent such upward winding, coolant may be jetted between the stringy swarf 50 that is wound upwards and the workpiece 30 to peel the stringy swarf 50 off the workpiece 30. Thus, in the present embodiment, the coolant is jetted in a substantially tangential direction of the workpiece 30 as shown in FIG. 7. In this way, the stringy swarf 50 that is wound upwards and the workpiece 30 are separated from each other and further entanglement of the stringy swarf 50 can be prevented. Because the coolant is jetted from a position higher than the cut point Pc to hit the stringy swarf 50 that is wound upwards higher than the cut point Pc, further entanglement of the stringy swarf 50 can be prevented.

Naturally, the position of the cut point Pc is gradually shifted along with a progress in the lathe-turning. It is necessary to control the position and the orientation of the jet nozzle 42 to continue appropriate guiding of the stringy swarf 50 with a shift in the cut point Pc. In order to meet such needs, the nozzle-holding device holding the jet nozzle 42 may have at least four degrees of freedom. Because in the present embodiment the jet nozzle 42 is held by the articulated robot 40 having at least four degrees of freedom, the position and the orientation of the jet nozzle 42 can be changed with a high degree of freedom.

The controller 46 may determine the position and the orientation of the jet nozzle 42 based on the position of the cut point Pc, machining conditions, or other factors. When the machining conditions are identical or similar, the flow direction of the stringy swarf 50 may also be similar to some degree. Thus, the position and the orientation of the jet nozzle 42 relative to the cut point Pc may be set for each machining condition and stored in advance in the controller 46 as guiding information. When performing lathe-turning, the controller 46 may read out the stored guiding information and determine the suitable position and the orientation of the jet nozzle 42 for the current machining condition. Then, the controller 46 may calculate the position and the orientation of the jet nozzle 42 based on the determined suitable position and orientation of the jet nozzle 42 and the current position of the cut point Pc and drive the robot 40 based on the obtained results. In another embodiment, by providing a visual sensor such as a camera in the machining chamber 12, the position and the orientation of the jet nozzle 42 may be determined based on the image data obtained by the visual sensor.

In either case, because in the present disclosure the coolant hits the stringy swarf 50 on the downstream side of the cut point Pc in the tool-feeding direction, entanglement of the stringy swarf 50 can be efficiently prevented. It should be noted that the configurations described above are merely examples. So long as the coolant hits the stringy swarf 50 on the downstream side of the cut point Pc in the tool-feeding direction, configurations may be changed as required.

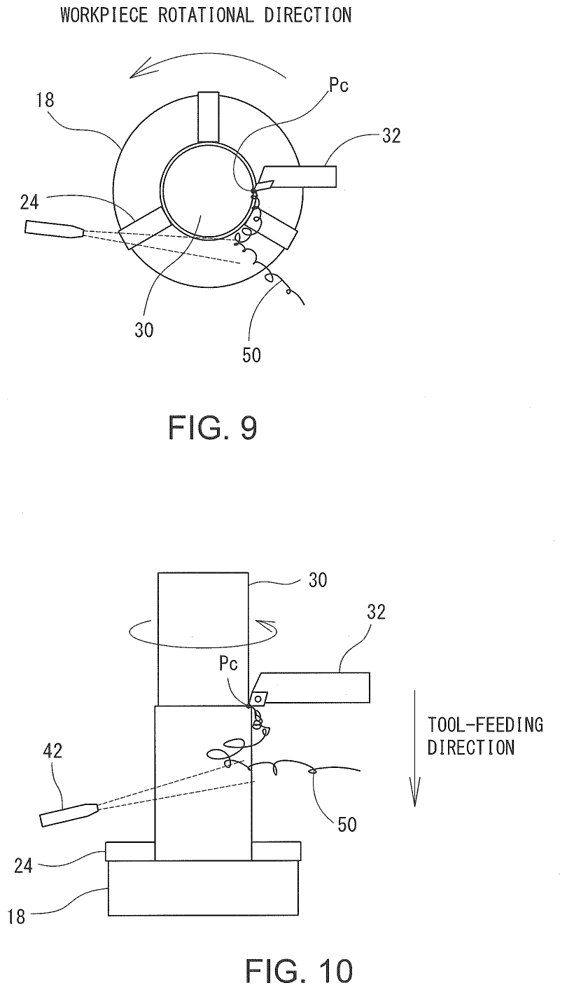

For example, although in the above description the coolant is jetted from a position higher than the cut point Pc, the coolant may be jetted from a position lower than the cut point Pc as shown in FIG. 9. Also in such a case, because the coolant is directed to a position on the downstream side of the cut point Pc in the tool-feeding direction, the coolant can easily hit the stringy swarf 50. Because the stringy swarf 50 is peeled off the workpiece 30 by the coolant that hits the stringy swarf 50, entanglement of the stringy swarf 50 around the workpiece 30 is prevented.

Although a horizontal lathe whose rotational axis of workpiece is horizontal is described above as an example, techniques according to the present disclosure may be applied to a vertical lathe whose rotation axis of workpiece is vertical. As shown in FIG. 10, the chuck 24 is disposed to face upwards in the vertical lathe, and the workpiece 30 is disposed to extend higher than the chuck 24. In such a vertical lathe, when the stringy swarf 50 hangs downward, the stringy swarf 50 may come into contact with the chuck 24. When the stringy swarf 50 gets caught on the rotating chuck 24 and is rotated together therewith, the stringy swarf 50 may be entangled or wrap itself around the workpiece 30, decreasing accuracy of the machined surface of the workpiece 30.

In the vertical lathe, the controller 46 controls the robot 40 such that the coolant jet direction is tilted upwards from a horizontal axis as shown in FIG. 10. In such a configuration, because the stringy swarf 50 is guided upwards, the stringy swarf 50 becomes less likely to come in contact with the chuck 24. Even in this case, because the stringy swarf 50 tends to flow downstream in the tool-feeding direction, the controller 46 controls the position and the orientation of the jet nozzle 42 such that the coolant hits the stringy swarf 50 on the downstream side of the cut point Pc in the tool-feeding direction.

Although in the description above the stringy swarf 50 is guided using the single jet nozzle 42, as no limitation is imposed on the number of the jet nozzle 42, one or more of the jet nozzles 42 may be employed. Two or more jet nozzles 42 may be attached to the single robot 40 (the nozzle-holding device), or two or more robots 40 (the nozzle-holding devices), each of which includes the single jet nozzle 42, may be provided.

The techniques according to the present disclosure do not deny an application of the coolant to the cut point Pc. Thus, in addition to the coolant to guide the stringy swarf 50, the machine tool 10 may jet the coolant to the cut point Pc to improve the life span of the tool 32 or accuracy of the machining surface.

The nozzle-holding device holding the jet nozzle 42 is not limited to the articulated robot 40. So long as the position and the orientation of the jet nozzle 42 can be freely changed, other devices, such as linear motion robots, may be used. Although in the above embodiments the coolant and air are mixed in the vicinity of an outlet of the jet nozzle 42 to increase the dynamic pressure of the coolant, the coolant alone may be jetted so long as sufficient dynamic pressure can be obtained.

### REFERENCE SIGNS LIST

10 machine tool, 12 machining chamber, 14 door, 16 enclosure, 18 spindle, 19 tailstock, 20 tool post, 22 turret, 24 chuck, 30 workpiece, 32 tool, 40 robot, 42 jet nozzle, 44 coolant source, 45 compressor, 46 controller, and 50 stringy swarf.

1. A swarf-guiding device guiding stringy swarf continuously generated from a cut point during lathe-turning, comprising:
a jet nozzle jetting coolant;
a nozzle-holding device holding the jet nozzle such that a position and an orientation of the jet nozzle are changeable; and
a controller controlling the nozzle-holding device such that the coolant hits the stringy swarf at a downstream position from the cut point in a tool-feeding direction.

2. The swarf-guiding device according to claim 1, wherein
the controller controls the nozzle-holding device such that the jet nozzle moves back and forth in the tool-feeding direction at a downstream position from the cut point in the tool-feeding direction.

3. The swarf-guiding device according to claim 1, wherein
the swarf-guiding device is mounted to a horizontal lathe in which a workpiece is held to be rotatable about a horizontal axis, and
the controller controls the nozzle-holding device such that a jet direction of the coolant is tilted downward from a horizontal axis.

4. The swarf-guiding device according to claim 1, wherein
the swarf-guiding device is mounted to a horizontal lathe in which a workpiece is held to be rotatable about a horizontal axis, and
the controller controls the nozzle-holding device such that the jet nozzle is located higher than the cut point and the coolant is jetted in a substantially tangent direction of the workpiece.

5. The swarf-guiding device according to claim 1, wherein
the swarf-guiding device is mounted to a vertical lathe in which a workpiece is rotatably held by a spindle directed vertically upwards, and
the controller controls the nozzle-holding device such that a jet direction of the coolant is tilted upward from a horizontal axis.

6. The swarf-guiding device according to claim 1, wherein
the nozzle-holding device is an articulated robot having at least four degrees of freedom.

7. The swarf-guiding device according to claim 1, wherein
the jet nozzle mixes the coolant and air at a distal end of the jet nozzle.
